(19) United States
(12) Patent Application Publication
(10) Pub. No.: US 2013/0314195 A1
(43) Pub. Date: Nov. 28, 2013

(54) FERROMAGNETIC TRANSFORMER CORES

(71) Applicant: Technetix B.V., Veenendaal (NL)

(72) Inventor: Jack Chapman, Burgess Hill (GB)

(73) Assignee: Technetix B.V., Veenendaal (NL)

(21) Appl. No.: 13/902,154

(22) Filed: May 24, 2013

(30) Foreign Application Priority Data
May 24, 2012 (GB) 1209086.6

(51) Int. Cl. H01F 27/255

(52) U.S. Cl. CPC H01F 27/255
USPC 336/212

(57) ABSTRACT

Ferromagnetic transformer cores comprise transformer beads with multiple holes or channels extending through the bead. The physical dimensions of individual core components are adjusted relative to each other to ensure that transformers to be associated with the core components are balanced in impedance.

### FIELD OF THE DISCLOSURE

This disclosure relates to improvements relating to ferromagnetic transformer cores and in particular cores comprising transformer beads with multiple holes or channels extending through the bead.

### BACKGROUND TO THE DISCLOSURE

Transformer cores in the form of transformer beads are used in CATV (cable television) distribution systems so that two transformers can be wound on a single ferrite core provided by the bead. Where two transformers are used, for example in a splitter circuit, any variations in magnetic permeability between the two transformers are removed due to the common ferrite core. This ensures that circuits in which such bead transformers are used can achieve good isolation as there are no variations in the ferrite permeability. However such bead transformers have been designed for small compact splitter assemblies mounted on printed circuit boards and whilst they can provide good isolation, they are not suitable for situations requiring low harmonics.

### SUMMARY OF THE DISCLOSURE

In accordance with the present disclosure, there is provided a transformer core or bead comprising a plurality of conjoined core components capable of bearing transformer windings, wherein physical dimensions of individual core components are adjusted relative to each other to ensure that transformers to be associated with the core components are balanced in impedance. Thus when the core or bead is used with windings so as to provide two or more transformers, each transformer formed by the combination of bead core and windings has a balanced or matching impedance. Thus the core can be used to provide a plurality of transformers, each with an equal impedance due to the adjustment of the physical dimensions of each core component. Such a core is of particular use in splitter assemblies where impedance needs to be balanced across the transformers used in the assembly.

The disclosure also includes a transformer assembly comprising a transformer core or bead comprising a plurality of conjoined core components, each core component carrying electrical windings and so forming a transformer, wherein physical dimensions of individual core components are adjusted relative to each other to balance impedance of the transformers. In this way, the transformer core can provide a series of transformers with matching impedance. One core component may carry windings of a first transformer and be adjacent to a second core component carrying windings for a second transformer which is in turn adjacent to a third core component carrying windings for a third transformer. The windings of respective adjacent transformers are electromagnetically coupled and by adjusting the physical dimensions of the core components, with all core components being formed from the same magnetisable material, the impedance of the series of transformers can be balanced.

Preferably the physical dimensions of each core component are different. Thus each core component may have different lengths. Where the conjoined core components incorporate a channel or hole for receiving transformer windings, the physical dimensions may be adjusted by altering the internal radius of the channel.

At least one groove may be formed between the conjoined core components extending between and parallel to the cylindrical channels. The groove acts to provide a flux gap such that when the transformer bead is used to carry two separate transformer windings, the groove interrupts the flux path occurring in the magnetic bead, or core. Cross-coupling is substantially reduced in the core so improving the properties of transformers provided by the combination of bead and windings, which in turn improves the performance of electronic circuits in which the transformers are used.

Preferably the groove has a tapered cross-section and more preferably outwardly curved side walls and a flat base. The groove is formed in an outer surface of the bead body.

Where the groove comprises outwardly curved side walls with a flat base, preferably the curvature of the curved side walls is complementary to a radius extending from a centre of the respective cylindrical channel to a closest outer edge of the body. Thus the groove subdivides the body into two substantially cylindrical portions to reduce unwanted flux effects. The first and second cylindrical channels may be associated with different radii in which case the groove will have curved side walls of different curvature.

If desired two opposing grooves may be provided in upper and lower outer surfaces of the bead body. Typically the upper and lower grooves directly oppose each other, spaced apart by a portion of the body.

The depth of the groove, or the combined depth of the upper and lower groove preferably ranges from 20 to 80% of the body height and more preferably between 40 to 60% of the body height, such that the groove depth is sufficient to introduce a flux gap between respective transformers formed by windings wound on the body.

The transformer bead may comprise additional cylindrical channels or holes and additional grooves such that at least one groove is formed between channels that are intended to receive separate transformer windings. Thus for example, the body may include four channels, the first and fourth channels intended to receive two separate transformers and the second and third channels receiving windings for a common transformer such that the four channels carry three transformers between them. In this situation, a first groove is provided between the first and second channels and a second groove between the third and fourth channels so as to interrupt flux paths between the three transformers.

The disclosure also includes an electronic circuit incorporating at least one transformer core as aforesaid and also in an electronic circuit incorporating a transformer assembly as aforesaid. In a related aspect, the disclosure includes a splitter assembly comprising at least one transformer assembly comprising a plurality of conjoined core components carrying associated electrical windings, with each core component in combination with the associated electrical windings forming a transformer, wherein physical dimensions of individual core components are adjusted relative to each other to balance impedance of the transformers.

### BRIEF DESCRIPTION OF THE DRAWINGS

FIG. 1 shows a schematic diagram of a CATV splitter circuit;

FIG. 2 shows a prior art transformer bead;

FIG. 3 shows a transformer bead in accordance with the present disclosure;

FIG. 4 shows a second embodiment of a transformer bead in accordance with the present disclosure; and

FIGS. 5 and 6 show further embodiments.

### DESCRIPTION

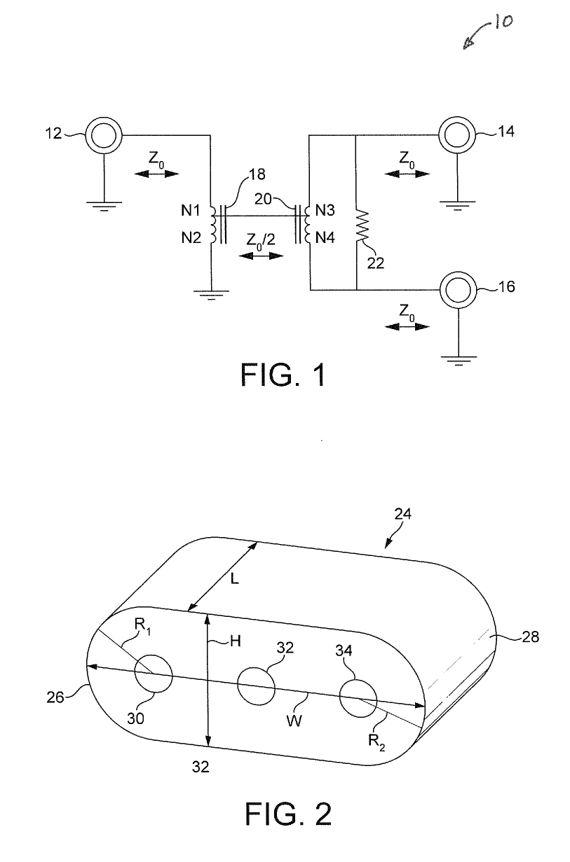

FIG. 1 shows a conventional CATV splitter circuit 10 with output ports 12, 14, 16, transformers 18, 20 and resistor 22. Depending on application, transformers 18, 20 are wound on separate transformer cores using different ferrite materials and are designed such that the impedance ratio of transformer 18 is 2:1 and transformer 20 is 1:1. It is also a requirement that the loaded impedance of winding N2 is equal to that of windings N3 or N4 for good isolation between ports 14 and 16. In CATV and satellite systems, very large bandwidths are required which can only be achieved by winding transformer 18 as an auto-transformer with typical turns of 7:5 (N2+N1:N2), or 4:3 for satellite applications, and transformer 20 with a bifilar winding of typically 2+2 turns. Respective transformer impedances of windings N2, N3 and N4 are relatively high in relation to the circuit impedance Z/2 or are equal which is the ideal situation. This ensures high isolation between ports 12 and 14.

In CATV distribution systems return path technology requires high signal levels to be introduced at the subscriber end of the network in order to transmit back to the headend where the signals originate from the CATV provider. This causes the introduction of second order harmonic and intermodulation products into the forward or downstream path from the provider to the subscriber. This occurs because of non-linear high permeability ferrite used in the transformers within such splitters. The high signal levels from the subscriber end of the network also raise the requirements for isolation between the input ports.

To reduce the harmonic and inter-modulation distortion at return paths of up to 60 MHz, it is necessary to use lower permeability ferrite for both transformers in the splitter. This in turn reduces the circuit impedance Zₒ/2 at low frequencies and whilst circuit modifications can compensate for these changes in terms of the splitter insertion loss and return loss requirements, the circuit becomes very sensitive to impedance variances between the two transformers. Ferrite manufacturers cannot supply batches of material to better than +20% permeability and this leads to poor production yields or expensive matching in order to achieve good isolation.

To solve this problem, it is known to wind the respective transformer windings onto a single ferrite core such as provided by a transformer core or bead 24, as shown in FIG. 2. This removes any permeability variations between the two transformers as they are both formed on a common core with the same permeability. This allows good isolation to be achieved irrespective of ferrite permeability.

Transformer bead 24 is made from a magnetic material such as ferrite. Typically the bead is made by adding appropriate binders and lubricants to a ferrite powder with the desired magnetic properties, pressing this mixture into a suitably shaped mould under a magnetic field and sintering at a high temperature. The bead is substantially cuboid with curved end walls 26, 28 with three cylindrical channels or holes 30, 32, 34 extending therethrough such that each channel is positioned to be a constant distance from the closest curved wall edge. Curved walls 26, 28 have respective radii or curvature of R₁ and R₂, R being the distance from the centre axis of the channel closest to the wall to the outer surface of the curved wall. Typically the width W ranges from 10 to 2 mm, the length L ranges from 10 to 2 mm and the height H ranges from 5 to 1 mm. Typically bead 24 will carry windings associated with two separate transformers, with transformer 18 normally pile winding around channel or hole 30 and transformer 20 wound between the other two holes.

Transformer beads formed with two or three channels for receiving windings are used in splitter applications as shown in FIG. 1 but have been designed to provide small compact splitter assemblies for printed circuit board applications where harmonics are not a problem. Such transformer beads are not suitable for use in the USA where there is a lower frequency 40 MHz return path and where a high splitter isolation is required, which such a bead using low permeability ferrite cannot provide.

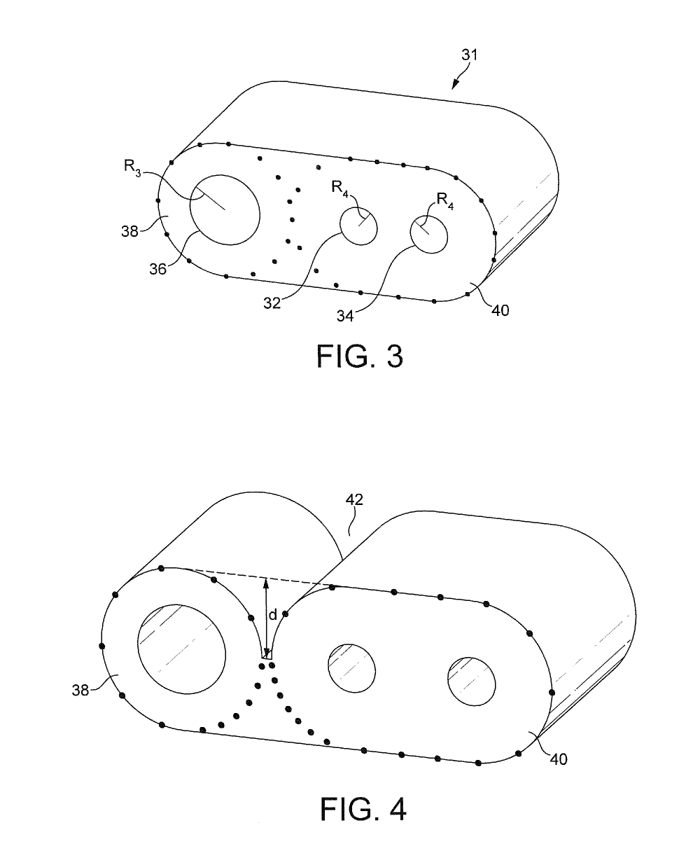

A transformer bead 31 in accordance with the present disclosure is shown in FIG. 3.

In the bead shown in FIG. 3, three channels or holes 32, 34, 36 are provided through the bead for receiving windings. Second and third holes 32 and 34 are to receive windings for a common transformer, with the first hole 36 receiving windings for a separate transformer. The bead thus effectively provides two core components 38, 40, shown for illustrative purposes using dotted lines. One component 38 is associated with hole 36 and a second component 40 is associated with the other two holes. Each bead core component and its respective windings forms a transformer once in use. By selecting the dimensions of the core components 38, 40 with respect to the windings they are going to receive, each transformer associated with bead 31 is impedance matched. Thus in this example internal radius R₃ of hole 36 is greatly increased over internal radius R₄ of holes 32, 34 with both components 38, 40 having the same length.

FIG. 4 shows a similar embodiment but incorporating a groove 42 so as to introduce a flux gap between conjoined core components 38, 40. Groove 42 runs parallel to and is equi-spaced from the cylindrical channels between which it is placed. The groove depth d is sufficient to introduce a flux gap when the bead is wound with windings associated with separate transformers. Typically the groove depth will be around 50% of height H although the maximum depth is that at which the ferrite can still retain structural integrity for a given thickness and not break. Thus d can be in the range 20% to 80% of height H.

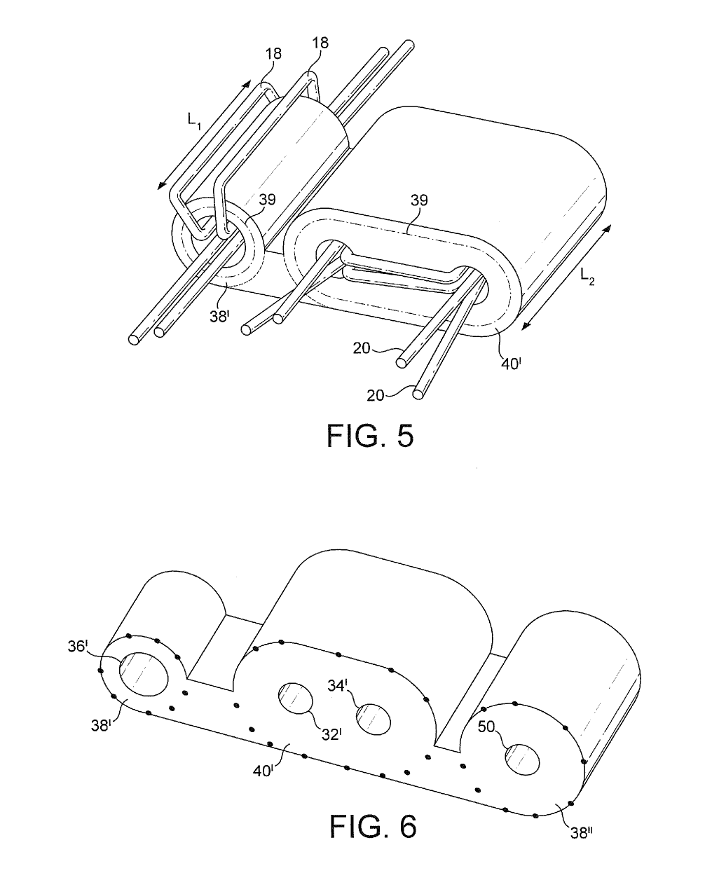

Groove 42 typically has a flat bottom with outwardly tapered side walls with the curvature of walls complementary to radii R₁ and R₂ respectively. Groove 42 effectively divides the bead into two cylindrical magnetic components with circular flux paths, see in particular flux paths 39 shown in FIG. 5, so that flux coupling between the two components is substantially reduced even though the components are connected.

FIGS. 5 and 6 show further embodiments of a transformer bead in accordance with the disclosure where both the inner and outer diameters and lengths of the components have been adjusted to ensure that a transformer resulting from the association of a core component with windings has the same impedance as other transformers resulting from windings on the other core components. Thus in FIG. 5 a transformer assembly comprising two transformers 18, 20 is shown. First core component 38′ has a length L₁ and a channel or hole of internal radius R₃ and external radius R₁ and is wound with primary and secondary windings to form a first transformer 18. Second component 40′ has a length L₂ and channels or holes with internal radius R₄ and external radius R₂ and is wound with primary and secondary windings of transformer 20. The depths of each core component are varied with L₁ greater than L₂ and the radii of channels or holes are also varied with R₃ greater than R₄. Transformer 18 is pile wound through a single channel or hole, and transformer 20 is wound between the other two channels or holes. The dimensions of each core component 38′, 40′, and for FIG. 6 also third component 38″, have been selected and adjusted relative to each other in view of the windings the channels are to carry.

When selecting the physical dimensions of each core component that is required to ensure that each transformer associated with the bead has a balanced impedance, the dimensions of each core component must be selected such that [N2]²Aₑ₁/Lₑ₁ for transformer 18 is equal to or closely approximates to [N3]²Aₑ₂/Lₑ₂ for transformer 20 and so on for successive transformers provided by windings associated with the beads. Aₑ₁ and Aₑ₂ are the effective magnetic cross-sectional areas of transformers 18 and 20, Lₑ₁ and Lₑ₁ are the effective magnetic lengths of transformers 18 and 20. Where such a relationship is followed the impedance of transformer 18 in FIG. 1 is equal to that of primary windings N3 of transformer 20 when both transformers are wound on the same bead with the same permeability.

By taking into account the windings with which the bead will be used, it is possible to provide a pre-characterised bead which in use ensures that transformers provided by a selected number of windings wound on this common bead have a common impedance.

By optimising the design of the bead in this way, low permeability ferrites can be used to provide transformers with high isolation together with low harmonics due to matching of the impedance, as a result of the low permeability. Such beads with appropriate windings can be used in systems with return path frequencies suitable for USA at around 40 MHz return path and also for Europe at around 60 MHz return path.

The arrangement shown in FIG. 6 is useful where one wishes to have three transformers, one associated with hole 36′, a second transformer associated with holes 36′ and 34′, and a third transformer associated with hole 50. Use of the third transformer is particularly useful as it may be used to provide 180 degree phase shift to the different transformers associated with the bead.

During manufacture the core components are pressed and sintered together, and/or machined together into a single bead or core which preserves the transformer balance. A flux gap can be incorporated if required to reduce cross coupling.

The described embodiments are particularly useful for splitter circuits used in CATV networks.

1. A transformer core comprising a plurality of conjoined core components capable of bearing transformer windings, wherein physical dimensions of individual core components are adjusted relative to each other to ensure that transformers to be associated with the core components are balanced in impedance.

2. A transformer core according to claim 1, wherein the physical dimensions of each core component are different.

3. A transformer core according to claim 2, wherein each core component has a different length.

4. A transformer core according to claim 1, wherein each core component incorporates a channel for receiving transformer windings and the physical dimensions are adjusted by altering the internal radius of one or more channels.

5. A transformer core according to claim 4, wherein at least one groove is formed between conjoined core components, the at least one groove extending between and parallel to the channels of the core components.

6. A transformer core according to claim 5, wherein the groove has a tapered cross-section.

7. An electronic circuit incorporating at least one transformer core in accordance with claim 1.

8. A transformer assembly comprising a transformer core comprising a plurality of conjoined core components, each core component carrying electrical windings and so forming a transformer, wherein physical dimensions of individual core components are adjusted relative to each other to balance impedance of the transformers.

9. A transformer assembly according to claim 8, wherein the physical dimensions of each core component are different.

10. A transformer assembly according to claim 9, wherein each core component has a different length.

11. A transformer assembly according to claim 8, wherein each core component incorporates a channel which receives electrical windings and the physical dimensions are adjusted by altering the internal radius of one or more channels.

12. A transformer assembly according to claim 11, wherein at least one groove is formed between conjoined core components, the at least one groove extending between and parallel to the channels of the core components.

13. A transformer assembly according to claim 12, wherein the groove has a tapered cross-section.

14. An electronic circuit incorporating a transformer assembly in accordance with claim 8.

15. A splitter assembly comprising at least one transformer assembly according to claim 8.
